(19) United States
(12) Patent Application Publication
(10) Pub. No.: US 2020/0151709 A1
(43) Pub. Date: May 14, 2020

(54) CRYPTO-CURRENCY BACKED STABLECOIN AND TOKEN LENDING FRAMEWORK

(71) Applicant: Andrew BRYAN, Sugar Land, TX (US)

(72) Inventor: Andrew BRYAN, Sugar Land, TX (US)

(21) Appl. No.: 16/682,789

(22) Filed: Nov. 13, 2019

Related U.S. Application Data
(60) Provisional application No. 62/760,666, filed on Nov. 13, 2018.

(51) Int. Cl. G06Q 20/36; G06Q 40/08; G06Q 40/04

(52) U.S. Cl. CPC G06Q 20/3678; G06Q 40/04; G06Q 40/08; G06Q 20/3672

(57) ABSTRACT

A financial engineering innovation involving a decentralized stable unit of account. This disclosure provides for a hybrid stablecoin of type cryptocurrency backed/non collateralized without a central counterparty by enabling participants to separate and transfer both volatility risk and event risk through an open source smart contract. Stablecoins are created and loaned out when cryptocurrency coins, tokens or other blockchain units are placed into the system as collateral and backed by insurers. Stablecoins are placed into the system as collateral and cryptocurrency coins, tokens or other blockchain units are loaned out and the loan backed by insurers.

### CROSS REFERENCE TO RELATED APPLICATIONS

This application claims the benefit of U.S. Appl. No. 62/760,666 filed Nov. 13, 2018, the contents of which is hereby incorporated herein by reference in its entirety.

### TECHNICAL FIELD

The present technology pertains to blockchain technologies, and in particular, a stablecoin for exchange and associated functionalities.

### BACKGROUND

With the advent of bitcoin, a new technological paradigm has taken hold and advanced, often referred to generally as blockchain or distributed ledger technology. Some common characteristics of this technology involve a mechanism for settling a transaction via a decentralized computational consensus which is maintained on an electric ledger. Accordingly, an electronic representation of value, such as a bitcoin, may be transmitted from a party A to a party B, such that party B is assured that it has obtained that bitcoin and party A cannot claw it back or send it to a different party, with a network of 3^{rd} party computers validating the transaction. The validated transaction is recorded on an electronic ledger, or blockchain.

Due to the reliability of the ledger and the transactions, bitcoin is often referred to as a cryptocurrency, and has been considered an electronic version of cash. Subsequent to bitcoin, blockchain technology advanced which allowed users to program their own applications which are processed via a blockchain, which may be called decentralized applications (DAPPS), or smart contract. Such DAPPS can result in the creation of additional representations of value often called tokens. One such project includes Ethereum, which employed smart contracts and permitted the issuance of tokens, which could be exchanged and validated on the ethereum blockchain. Additional early projects include EOSIO and Cardano each having different mechanisms for processing a blockchain transaction and creation of DAPPS.

Processing of blockchain transactions are often incentive by payment of an underlying value of a blockchain system. For instance, for processing the transfer of a bitcoin transaction, an amount of bitcoin is paid for by a party to a party processes the transaction. Similarly, a transfer of Ethereum, or tokens, between parties is paid for by value called ether to a party who processes the transaction. However, projects such as EOSIO have found ways to eliminate fees for users. Often, the primary underlying currency that is often referred to as a coin, and secondary representations of value that are issued based on DAPPS are called tokens.

With the rise in popularity of blockchain coins, tokens and cryptocurrency (also referred to as “crypto”), exchanges arose which facilitated the exchange between different types of blockchain based representations of value. Some exchanges also provided an exchange between the electronic representations of value, coins and tokens, with government fiat such as United States dollar (USD), Euro, Chinese yuan, Japanese Yen, Korean won and so on.

Additionally, with increased exchange, between individuals using electronic wallets, as well as large public exchanges, broad fluctuations in market pricing of such blockchain-based coins and tokens occurred. In order to avoid such wild fluctuations or to avoid having to exchange to government fiat, stablecoins were introduced.

Stablecoins are digital representations of value processed on a blockchain which are often pegged to a government fiat or some predetermined value. For example, one of the first stablecoins is a cryptocurrency known as Tether. Tether was issued by the Bitfinex exchange with each Tether purportedly backed by a real USD, such that one Tether equals one USD. In addition to real world asset backed stablecoins, there arose two additional stablecoin types. The first is crypto-currency backed and in this case the underlying value of reference is given by usually a basket of other major cryptocurrencies (like Bitcoin, Ethereum or Ripple) owned either by the token holder or the issuer. The second type is Non-Collateralized and in this category of stablecoin each unit does not directly represent another asset and its value, and the stability characteristics are given by a different mechanism, for example a complex “seigniorage” algorithm or other processes not involving an immediate backing of a commodity, a currency or a cryptocurrency.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. The embodiments herein may be better understood by referring to the following description in conjunction with the accompanying drawings in which like reference numerals indicate analogous, identical, or functionally similar elements. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an economic balance sheet including an exemplary solvency ratio implemented in accordance with various embodiments;

FIG. 2 illustrates how Solvency Capital Requirements (SCR) may be obtained in accordance with various embodiments;

FIG. 3 illustrates an example portfolio loss distribution in accordance with various embodiments;

FIG. 4 illustrates a structured product, namely, transferring risk with a basket of token event swaps (TES) and a single TES written on a basket of collateral;

FIG. 5A-C illustrate an example blockchain network in accordance with some examples of the present disclosure;

FIG. 6 illustrates an example blockchain configuration in accordance with various embodiments; and

FIG. 7 illustrates an example computing device architecture in accordance with various embodiments.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

It should be understood at the outset that although illustrative implementations of one or more embodiments are illustrated below, the disclosed apparatus and methods may be implemented using any number of techniques. The disclosure should in no way be limited to the illustrative implementations, drawings, and techniques illustrated herein, but may be modified within the scope of the appended claims along with their full scope of equivalents. The various characteristics described in more detail below, will be readily apparent to those skilled in the art with the aid of this disclosure upon reading the following detailed description, and by referring to the accompanying drawings.

### I. Introduction

Stablecoins, in order to maintain confidence and value, have been generally backed by either government fiat or on-chain blockchain assets, such as cryptocurrency. Given that cryptocurrencies are subject to large and volatile market pricing fluctuations, any stablecoin backed by one or more cryptocurrencies are subject to the risk that such cryptocurrency market value falls so low that stablecoin resultantly loses the basis for its value. Accordingly, cryptocurrency backed stablecoins have not previously had adequate financial engineering specification in their design to account for the risk of the underlying asset on which its stability is based. This leaves stability in doubt and leads to intractable governance and limited scalability. Also adoption has been muted as a result of projects ignoring key elements of behavioral finance. Previous stablecoins have suffered from weak financial engineering, including arbitrary loan pricing with no financial model nor market price discovery, inefficient loan pricing set by token holder voting, complete lack of risk modeling, participants having no way to know if risk/return is attractive, no stress testing performed nor considered, and underestimating frictions involved with bailout/recapitalization methods that auction tokens into distressed markets.

The technologies disclosed herein provide various technical advantages and improvements by, for example, modeling events or conditions, such as price events and risk conditions, introducing market based price discovery for lending based on risk budgeting and on-chain transparent capital adequacy modeling, and tracking items, such as assets, in a decentralized, distributed computing environment where events or conditions occur and at a very rapid pace and can be extremely difficult to manage, monitor, or process. Transactions may be immutably carried out with high reliability in a trustless manner (little to no trust between parties) on a distributed computer and/or blockchain architecture. Advancements related to providing a hybrid crypto-currency backed, non collateralized stablecoin and lending platform are provided herein with additional insuring and borrowing components without parties knowing one another or requiring trust between the parties.

Disclosed herein is a financial engineering innovation with regards to a decentralized stable unit of account. This disclosure provides for a cryptocurrency backed stablecoin without a central counterparty by enabling participants to separate and transfer both volatility risk and event risk through an open source DAPP or smart contract. Stablecoins are created and loaned out when cryptocurrency coins, tokens or other blockchain units are put into the system as collateral and backed by insurers.

Blockchain discussed herein includes any electronic distributed ledger technology, where transactions are processed via decentralized computational consensus, where a unit of value or representation is transferred between parties. Such unit of value or representation may simply be a number or an indication of a number. The unit of value or representation may be a sub-amount or portion of an initial number of units created via the blockchain base software platform. A blockchain may have at its creation or at various times during its pendency, a specified total number of units, which may be traded between parties, where the total number of units remain the same or may grow or decrease at predetermined times as programmed in the code of the blockchain. Some blockchains are directed only to processing such units, others use such units to alternatively or additionally process DAPPS. The base unit of the blockchain is often called a coin, and subunits created by DAPPS on the blockchain are often called tokens.

By design, blockchains are inherently resistant to modification of stored data. Functionally, a blockchain can serve as an open, distributed ledger that can record transactions between two parties in a verifiable and permanent manner. The blockchain implemented in the ecosystem herein enables testing an entire population of transactions within a given period—a significant advance in the realm of audits.

When a transaction, such as a DAPP or transferring unit, is processed, the coin or token may be transferred between two or more parties, including parties that do not know each other and also parties processing the transaction. Blockchains software platform and its transactions may be public and open to use by any individual, or may be enterprise or private. The blockchain units herein include coins, tokens, stablecoins, cryptocurrency or other units. The term cryptocurrency encompasses coins and tokens or other blockchain units. The crypto-prefix referring to the strong cryptography usually associated with most blockchains and the verification protocol of the blockchain which secures most transactions and enabling trustless transactions between parties.

Various blockchain technologies may be used for implementing the disclosure herein, including Bitcoin, Ethereum, EOSIO native blockchains, Cardano, Stellar, Tron, or any other public or private blockchain. A particular blockchain protocol for use herein includes EOSIO native blockchains. EOSIO may be found at https://eos.io/, having a base cryptocurrency units called EOS on the first launched such blockchain referred to as mainnet and having many other sisterchains and sidechains. The EOSIO native blockchains include smart contracts which may involve the issuance of tokens. The stablecoin discussed herein may be issued on ESOIO native blockchains. The stablecoin herein may be a token, and may be referred to herein for convenience as VIGOR (or previously used symbol names such as TANDEM, USDM, or eosUSD) or otherwise referred to herein as a stablecoin.

The smart contracts herein can be a contract written in computer code with terms or rules for verifying/validating data and/or transactions, formatting data, deduplicating data, enforcing contracts, etc. The smart contracts herein can verify, execute and/or enforce a contract such as stablecoin, borrowing or lending based on the terms written in the computer code.

A. The Involved Parties

This disclosure introduces a decentralized system of borrowing and insuring, including a cryptocurrency credit facility with three distinct independent participants: (1) borrowers, (2) insurers, and (3) custodians.

B. Borrower Party

Borrowers post cryptocurrency as collateral, and may be referred to herein as “cryptocollateral”, which is a type of asset. Posting cryptocurrency here involves interaction with the underlying blockchain, for instance a DAPP may be programmed, which permits the logging or notation in the blockchain or DAPP that a party has the cryptocurrency and that it is locked based on the DAPP contract. For instance the blockchain being used may be EOS. The borrower may post EOS as collateral. While EOS is used as an exemplary blockchain, any blockchain may be used. The cryptocurrency posted as collateral may be issued or based on or otherwise from the same underlying blockchain, or it may be any cryptocurrency or other units from other blockchains. For brevity, in the present disclosure when an action referred to herein by a party is taking place it involves interaction with an on-chain or off-chain with an interaction ultimately with the underlying blockchain via a programmed DAPP.

Upon posting the cryptocurrency asset, the borrower receives (takes) an amount of stablecoin. The receiving of the stablecoin may be considered a loan of stablecoin with the posting of the cryptocurrency as collateral for the loan, which may be referred to as cryptocollateral asset. The stablecoin may be a token issued on the underlying blockchain processing the transaction. The stablecoin is designed to induce confidence to market participants that the value of one stablecoin should equal one unit of a common pricing currency such as US Dollar based on the collateral backing, the insurance pools, and the algorithm described in this current work. The pricing currency could be any single or basket of real world currencies (fiat currencies such as US Dollar, Euro, Korean Won, Japanese Yen, Chinese Yuan) or cyptocurrencies. The borrower may post the cryptocollateral from an electronic or virtual wallet which interacts with the blockchain, and may receive the stablecoin into the wallet. The stablecoin loan is made on the basis of contributing and maintaining excess cryptocollateral and purchasing insurance which will be further described below.

With posting of the cryptocollateral asset, the borrower may also protect the cryptocollateral asset by paying a fee to an insurer party in the form of the DAPP system utility token. The DAPP system utility token is different and distinct from the stablecoin or the cryptocurrency posted by the borrower. The DAPP system utility token may also be referred to herein as a utility token, and herein may be referred to as VIG (previous symbols were TANDEM, or GOVT).

Ownership and usage of the utility token, such as holding within an electronic wallet, by an owner, and using it on the platform provides utility. Ownership of the utility token allows access to the software platform. User activity is then measured inside the platform, making the user potentially eligible to eventually elect Custodians and build a positive user history similar to a credit score, but by and in itself owning, purchasing, trading or holding this token does not grant any right of membership and/or vote over the DAC whose custodians manage the DAPP by voting on proposals to set targets and limits on stablecoin, collateral and loans.

Insurer Party

The insurers post cryptocurrencies to an insurance asset pool. The DAPP maintains a pool of all cryptocurrencies posted from one or more or a plurality of independent insurer parties. This pool may consist of an index or pointers to the multiple parties and/or maintenance of an electronic ledger via the DAPP. The insurers receive a fee from the borrower for posting the cryptocurrency, the fee being paid in the form of the DAPP system utility token.

The amount of fee payment received by the insurer is commensurate with contribution to risk of the insurer asset pool. If the cryptocollateral asset posted by the borrower declines too far in value, by a predetermined amount, the insurer takes over ownership of the cryptocollateral asset and/or otherwise recapitalize undercollateralized loans.

The insurer also may also have voting rights as users in the same way that borrowers have regarding electing custodians to manage aspects of the DAPP which may include targets and limits on stablecoin, collateral and loans.

Managers or Custodians

Custodians (previously may be referred to as Managers) assist in management of the DAPP disclosed herein. Custodians are elected by users of the utility token. The Custodians create and vote on proposals for design and upgrades to the DAPP and carry out the execution of proposals. Some portion of the utility token paid in is used as final reserves which acts as an insurer of last resort to back stablecoin loans after a major decline of the cryptocollateral asset value.

To ensure a self-sustaining ecosystem balanced by borrowers and insurers while being robust to extreme events the smart contract implementation focuses heavily on the duality:

Pricing: model and market price discovery.

Risk: robust risk profiling framework.

In some embodiments, the platform is non-custodial. The tokens are always either in the users account or the stablecoin contract which run autonomously.

II. Risk Framework

A. Credit Enhancement

There are two types of credit enhancement used which enable prudent lending. One is overcollateralization (margin or haircut), which refers to holding an amount of collateral that exceeds the value of the loan and can provide a buffer against fluctuating collateral prices. The second is insurance, which is used to protect collateral value against catastrophic price events. Borrowers insure their collateral by buying (paying utility token) protection on a Token Event Swap (TES), an innovative smart contract which triggers bail-out if a price event occurs in exchange for premium payments(paying utility token). Insurers take on risk to earn the premium (earning utility token) and provide backing by posting cryptocurrency collateral into the insurance pool.

B. Credit Enhancement

The stablecoin will have a stable value to the extent that loans either have excess collateral or that the insurance is sufficiently capitalized. Therefore, modeling capitalization of the insurance is a component of the DAPP contract disclosed herein. In some aspects, the system, or DAPP, applies the Solvency II risk framework used by insurance regulators in the EU. Other solvency risk frameworks may also be successfully employed.

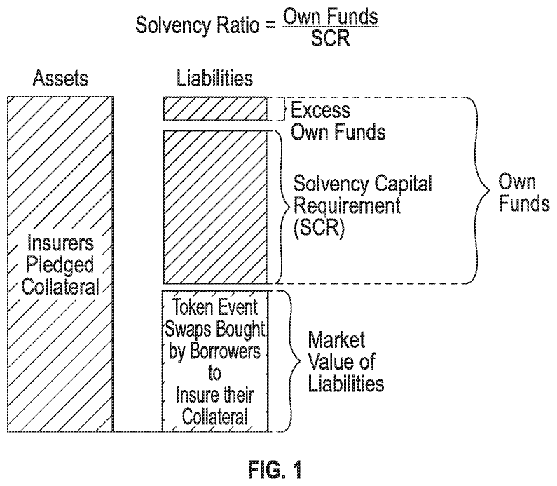

A solvency ratio measures an insurers ability to bail-out undercapitalized loans. FIG. 1 illustrates an economic balance sheet including an exemplary solvency ratio. As shown in FIG. 1, Own Funds is the amount of cryptocurrency collateral insurers have pledged (assets) above the market value of the token event swap (TES) insurance that borrowers have purchased (liabilities). The Solvency Capital Requirements (SCR) is defined as the required amount of owned funds needed (to survive a stress event for a given tolerance of certainty) for a given level of solvency. The solvency ratio greater than 100% is an example limit set by mangers of the DAPP system disclosed herein.

The far left column in FIG. 1 shows the cryptocallateral assets pledged, with the second column showing liabilities which is a sum of (1) the Excess Own Funds, (2) the SCR, and (3) the market value of liabilities, which is the token event swaps bought by borrowers to insure their collateral. The SCR and the excess Own Funds is part of Own Funds. And as shown the Solvency ratio is defined as:

$$Solvency Ratio = \frac{Own Funds}{SCR} \qquad ( A )$$

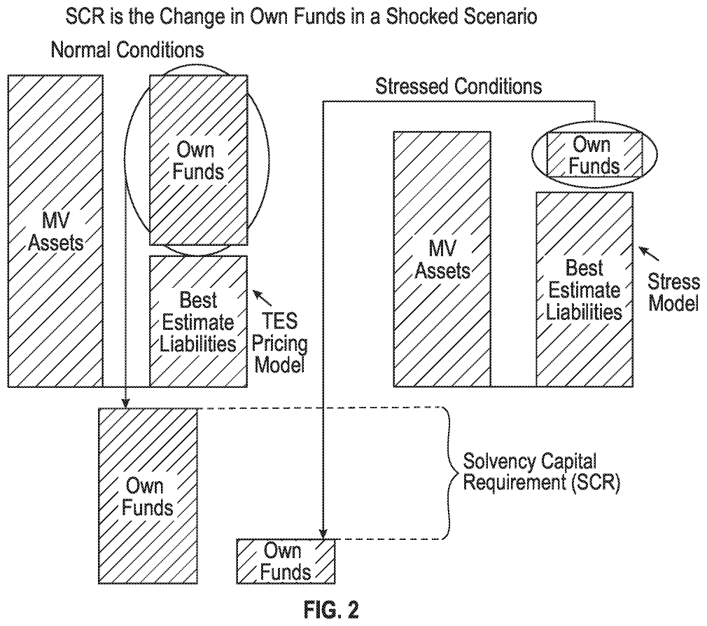

FIG. 2 illustrates how SCR may be obtained. As shown in FIG. 2, SCR is the change in Own Funds between normal and stressed markets. To arrive at SCR, the core operation is to conduct a stress test per a risk framework such as Solvency II which provides information about the required quantity of cryptocurrency collateral that should be pledged by insurers to maintain solvency. For this stress test, the DAPP implements a TES pricing model to provide a best estimate for market value of the TES liabilities in normal conditions and a stress model for what their shocked value might be (given varying levels of certainty). Own Funds equals the amount of cryptocurrency collateral pledged by insurers minus a best estimate normal market value of the TES contracts. Stressed Own Funds equals the stressed value of cryptocurrency collateral pledged by insurers minus a best estimate stressed value of the TES contracts. Finally, SCR is the change in Own funds due to stressed markets and Solvency Ratio is the ratio of Own Funds to SCR.

C. Stress Model

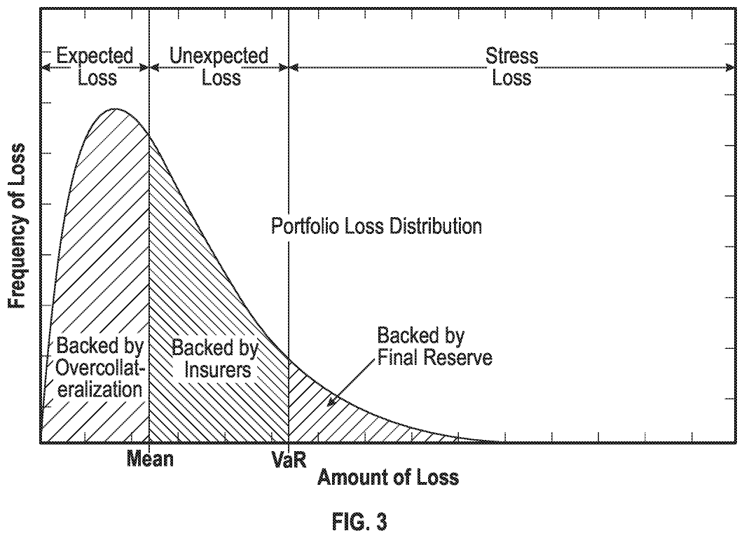

The stress model may be a copula based Monte Carlo simulation of correlated extreme price events. While Monte Carlo simulation is illustrated herein, other stress models may be used such as parametric models like expected shortfall or CVaR conditional value at risk or historical models. The Monte Carlo simulation generates the portfolio loss distribution as in FIG. 3. Results of the stress model has three categories of loss, including (1) expected loss which is backed by overcollateralization, (2) unexpected loss which is backed by insurers, and (3) stress loss which is backed by the utility token final reserves (see subsection II-F below). Three inputs to this model are (1) probability of each collateral asset having an extreme price event, (2) their correlation, and (3) the amount lost (1-recovery) due to an event. Probability (derived from hazard rate) and recovery are obtained from TES market prices (see subsection III-B Price Discovery below). Correlations will be modeled from cryptocurrency asset returns through common latent factors and a stressed scenario of the correlation structure will be used. This stress model is used primarily to simulate unexpected loss to obtain SCR and Solvency Ratio but will also provide a measure of capital efficiency and risk concentration (Risk Adjusted Return on Capital and contribution to RAROC) to indicate system health. Similarly inputs to an alternate CVaR stress model would be implied volatility extracted from TES market prices.

D. Structured Product

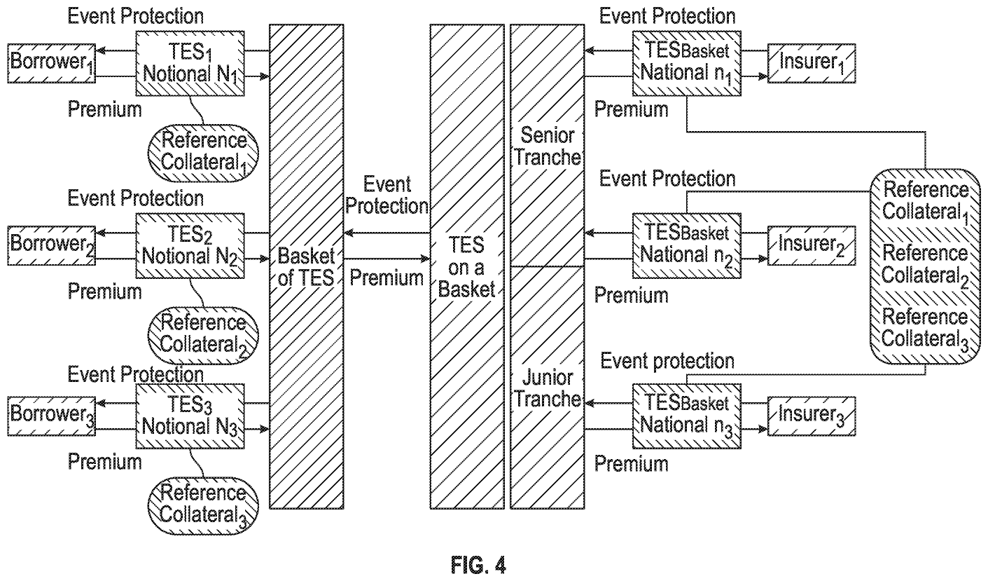

FIG. 4 illustrates a structured product, namely, transferring risk with a basket of token event swaps (TES) and a single TES written on a basket of collateral. All TES loan insurance contracts written to insure collateral are taken together as a basket of TES to form an aggregated insurance premium. Insurers take the other side by selling protection on notional amounts of a basket TES (a single TES written on a basket of collateral), as shown in FIG. 4. The basket TES may be tranched.

E. Bail Out.

A TES is triggered for bail-out if collateral value falls below the value of debt for a given loan. If a TES or is triggered then the basket TES protection insurance sellers would immediately take-over (take ownership of) and recapitalize the undercollateralized loan realizing a loss. Gains and losses of the insurance asset pool is shared across sellers. Participation is commensurate with contribution to solvency defined as the change in Solvency Ratio resulting from a given TES seller posting cryptocurrency collateral into the insurance pool. Handling bail-outs does not require auctioning collateral into distressed markets; the basket TES is both funded and physically settled.

F. VIG Final Reserve

Premiums paid-in by borrowers is required to be denominated in the utility tokens (e.g., VIG) and must be posted prior to drawing loans; insufficient maintenance of the utility tokens (e.g., VIG) balance triggers bail-out of the loan with borrower retaining any excess collateral and counts negatively towards crypto credit score. Insurers are paid denominated in utility tokens.

The system stores a portion of utility token (e.g., VIG) premiums paid in as final reserves after payment to insurers. VIG final reserves is used to bail-out the system if at any time the insurance asset pool is depleted, covering the so-called stress losses as depicted in FIG. 3.

### III. Pricing Framework

A. Pricing Model

The TES contract delivers a protection payment (the cost to bail-out an undercollateralized loan) at the time of the triggering event, defined as the token price declining below a pre-specified triggering barrier level (value of cryptocurrency collateral falling below the value of debt). In exchange the TES protection buyer makes periodic premium payments at the TES rate up to the triggering event.

The TES pricing model is based on the jump-to-default extended constant elasticity variance model by Carr, P., and Linetsky, V. A Jump to Default Extended CEV Model: An Application of Bessel Processes. Finance and Stochastics 10, 3 (2006), 303330, known as JDCEV where the token price is modeled as a diffusion, punctuated by a possible jump to zero:

dXₜ=[r+h(Xₜ)]Xₜdt+σ(Xₜ)XₜdBₜ (1)

where r is risk free rate, σ (Xₜ) instantaneous token volatility, and h(Xₜ) is the state dependent jump-to-default intensity (hazard rate).

To capture the negative link between volatility and token price, there is assumed a constant elasticity of variance (CEV) specification for the instantaneous token volatility prior to extreme price events:

σ(x)=ax^{β} (2)

where β is the volatility elasticity parameter and a is the volatility scale parameter.

To capture the positive link between extreme price events and volatility, the hazard rate is an increasing affine function of the instantaneous variance of returns on the underlying token:

h(x)=b+cσ⁻²(x)=b+cσ²x^{2β} (3)

where b is a constant parameter governing the state-independent part of the jump-to-default intensity and c is a constant parameter governing the sensitivity of the intensity to the local volatility σ².

The TES price (aka premium rate) is obtained following M Mendoza-Arriaga, Vadim Linetsky, Pricing Equity Default Swaps under the Jump to Default Extended CEV Model, Finance and Stochastics, September 2011, Volume 15, Issue 3, pp 513540, as the rate Q that equates the present value of the protection payoff to the present value of the premium payments.

The protection payment is the specified percentage (1−r) of the TES notional amount that the TES pays out to takeover the undercollateralized loan (r is the “recovery rate” and 1−r is the “loss-given-the-triggering barrier crossing event”):

$$PV ( protection ) = ( 1 - r ) ( {\int }_{0}^{T} {e}^{- r \cdot u} {𝔼}_{x } [ {e}^{- {\int }_{0}^{u} h ( {X}_{u} ) dv} h ( {X}_{u} ) {\{ {T}_{L} > u \}}_{} ] du + {𝔼}_{x } [ {e}^{- r \cdot {T}_{L} - {\int }_{0}^{{T}_{L}} h ( {X}_{u} ) du} {\{ {T}_{L} \leq T \}}_{} ] ) \qquad ( 4 )$$

The first term in parenthesis is the payoff triggered by a jump and the second term is the payoff if the token price hits the barrier by diffusion.

The present value of all premium payments made by the TES protection buyer is:

$$PV ( premium ) = Q \cdot Δ \cdot {\sum }_{i = 1}^{N} {e}^{- r \cdot {t}_{i}} {𝔼}_{x } [ {e}^{- {\int }_{0}^{{t}_{i}} h ( {X}_{u} ) du} {\{ {T}_{L} \geq {t}_{i} \}}_{} ] \qquad ( 5 )$$

where L is the barrier, T is the horizon, N is the number of premium payments, Δ=T/N is the time between premium payments, ti=Δ·i, i=1, 2, . . . , N is the i^{th} periodic premium time, TL is first hitting time.

As collateral price and volatility change over time the premium charged to the borrowers (pricing) is adjusted using the TES pricing model; borrowers actually pay a floating premium rate. Premiums adjust inversely proportional to collateralization levels and proportional to level of collateral token volatility.

The basket TES is priced as a DV01 weighted average basket of TES spreads and the tranche pricing uses a Gaussian copula factor model as in Wang D., Rachev S. T., Fabozzi F. J. (2009) Pricing Tranches of a CDO and a CDS Index: Recent Advances and Future Research. In: Bol G., Rachev S. T., Wrth R. (eds) Risk Assessment. Contributions to Economics. Physica-Verlag HD.

An alternate pricing model which can be used to re-define previously what may be referred to as a TES (token event swap) in section III Pricing Framework, is the cash or nothing binary put option or (or call option to redefine the upside TES). The binary option model has similarities to an equity default swap, the former is based on equity models whereas the latter is based on credit derivatives modeling. The Black Scholes binary option pricing model can be used for the binary option. Using this closed form alternate pricing model is more tractable for on-chain real time computation and is an acceptable simplification because the purpose of the pricing model is not a primary mechanism to “set” prices but is a secondary tool to aid in market price discovery by simplifying user experience. The role of the pricing model is to predefine the pricing curve across moneyness (value of collateral minus debt amount) reducing the dimensionality (and to obtain implied parameters for the stress test).

B. Price Discovery

This section describes how market based price discovery is achieved. TES model prices offered to borrowers are scaled higher or lower to drive Solvency Ratio to a target set by custodians (such as 100%). The “right” price of loan insurance should lead to a balance between loan collateral and insurance assets. The concept is similar to option market makers updating implied volatility based on order book imbalances. Three parameters in the pricing and risk models are scaled in an effort to drive Solvency Ratio closer to its target: hazard rate function parameters, b and c as in Eq. 3 as well as recovery r as in Eq. 4. If the binary option pricing model is used then the volatility parameter is scaled. Said another way, the innovation here includes that the market price discovery mechanism is not through the use of a limit order books nor trading, but based on risk budgeting. The system is stress tested to find the solvency capital requirement necessary to survive a market stress event. If the system is not adequately capitalized relative to the requirement then solvency is less than 100% and prices adjust higher to attract more insurers and reduce further loan demand. It is price discovery based on the supply and demand of capital considering risk budgeting. Every user transaction is a credit or debit to the risk budget, and prices adjust to keep the budget balanced. Also if one puts up more collateral against one's loan, the rate is lower because the more collateral put up, the less insurance one needs to buy.

C. Stability

The stablecoin is designed to induce confidence to market participants that the value of one stablecoin should equal one unit of a common pricing currency such as US Dollar based on the collateral backing, the insurance pools, and the algorithm below:

1) Crypto-Overcollateralized

Stability depends firstly on the level of overcollateralization which covers expected losses. The system will price the collateral in a pricing currency (such as USD), and overcollateralization is defined as USD value of collateral minus number of stablecoins of debt. This system is extendable to create stablecoins that use other pricing currencies including other fiat currencies, baskets of fiat, low volatility baskets of cryptocurrency etc.

2) Collateral is Insured

Loan insurance covers a decrease in value of the crypto collateral below a threshold (face value of the stablecoin loan). So event risk and volatility of the collateral is transferred to insurers. Stability then also depends on the level of capital adequacy or solvency of the insurance. The system scales insurance pricing through implied hazard rates and recovery rates (or volatility) to drive Solvency Ratio to the target set by custodian vote.

3) Utility Token (VIG) Final Reserve

The insurance asset pool represents capitalization to cover unexpected losses estimated by the stress model to a degree of certainty specified by custodians. Actual losses may prove worse due to model risk. So a percentage of fees that is paid-in by borrowers and denominated in the utility token (e.g., VIG) are diverted into and capitalize the final reserve which backs the insurance pool as a lender of last resort covering so-called stress losses.

4) Solvency Target

Custodians vote to set the target solvency giving them the power to run the insurance business from conservative to aggressive.

### IV. Governance

The system's decentralized autonomous corporation (DAC) will be a decentralized autonomous community run by custodians voted in by the user of the utility token. Custodians vote on all issues concerning the running of the DAC, including appointment of the core team who will manage day to day operations. Tools and DAPPS will be developed through community worker proposals. Initially the DAC is run by a core team as the DAC is being created and implemented. Adoption may be the same or similar DAC framework as eosDAC.

### V. Token Lending Facility

This disclosure has addressed up to this point borrowing of stablecoin through a cryptocurrency credit facility. Introduced in this section are future capabilities for a cryptocurrency lending facility which allows borrowing and lending of cryptocurrency assets through the use of an upside TES and an implied zero cost collar. A lender will be able to post cryptocurrency assets, such as tokens, for lending and earn insurance premium for taking exposure to bail out risk of upside price events. A cryptocurrency asset borrower would post stablecoin as collateral and pay upside TES insurance premiums as they borrow cryptocurrency assets and take the other side of the collar (or synthetic futures). This may or may not create another insurance pool and structured product for a basket of upside TES. This is a key innovative feature that no other platform offers; to offer both sides of the market.

### VI. Token Allocation

The utility token (e.g., VIG) has four main utilities in the system:
(1) Fee token providing access to the stablecoin software platform.
(2) Final reserve for backing of stress losses. As VIG is paid into the reserve over time, the free float of VIG reduces such that it is more scarce.
(3) Users of VIG have vote power to elect custodians who vote for and execute system design changes and upgrade, and management of targets and limits
(4) users of VIG can build a cryptocurrency credit score. Borrowers build good credit by avoiding bailout due to either insufficient maintenance of their collateral levels or insufficient VIG payment balance.
The utility token (e.g., VIG) will have a fixed supply of 1 mm tokens and will be allocated as follows:
(4) 13% community: Airdrop or Airgrab etc, to non-US persons.
(5) 50% DAC fund: for candidates of the DAC for developing the smart contracts and user interface, research, engineering, deployment, business development, marketing, distribution, legal, staking resources etc.
(6) 7% airdrop to eosDAC and core telegram community, who are non US persons
(7) 30% DAC long term fund: for long-term network governance, partner support, academic grants, public works, community building, etc. Other amounts of utility tokens may be employed and at different percentages than the above.

### VII. Conclusions

The stablecoin system disclosed herein innovates the crypto-backed decentralized stable unit of account. The system creates a decentralized credit facility that enables trustless crypto-secured financing. It creates the first decentralized market where borrowers and insurers interact to separate and transfer both volatility risk and event risk embedded in token prices.

Thus the system creates the stablecoin and a token event swap TES. Market based price discovery is a key feature which minimizes price inefficiencies to the benefit of users. The system algorithm focuses on financial engineering specification of risk, stress testing, price modeling and price discovery to ensure sufficient backing of the stablecoin and should provide for transparent and concise voting agendas. The bailout mechanism is low friction; designed to avoid auctioning of collateral into distressed markets. We unlock scalability with a system that can handle more leverage e.g. users increase loan insurance if they have low collateral levels. The system can be viewed as necessary protocol layer for a robust crypto-backed stablecoin system that scales, has tractable governance, and on top of which we can deploy a wallet with automated features that users care about. An innovative feature is token lending, the ability to borrow crypto tokens against stablecoins collateral; this completes the platform as it is the other half of the market next to borrowing stablecoin against collateral. In the future we see the potential for users to build a crypto credit score a natural application of identity on the blockchain.

The VIGOR DAC will be a decentralized autonomous community owned and run by its members to build stablecoin technology.

Minimum Viable product

A minimum viable product (MVP) may include or consist of a smart contract deployed to the blockchain to allow either one or both of (1) borrowing stablecoin backed by cryptocurrency and (2) borrowing crypto against stablecoin (to perhaps short sell on secondary markets). The specific actions and functions of the MVP allow for the following: functional mechanics, risk measurement, pricing, performance measurement, fee payment, bailouts, user voting, and credit scoring. Functional mechanics allow users to deposit/withdraw risky crypto tokens for collateral against which to borrow stablecoin, deposit/withdraw stablecoin for collateral against which to borrow risky crypto tokens, deposit/withdraw risky crypto tokens and/or stablecoin into the insurance/lending pool, and performs valuation updates for all tokens in the contract based on oracle price feeds.

Risk measurement functions perform market stress tests on the collateral, insurance, and reserve (for example expected shortfall, CVaR) to determine a solvency capital requirement (based on frameworks such as Solvency II regulatory requirements in the European Union). The capital requirement is the capital needed to service all debt in the event of market stress thus ensuring that the stablecoin is adequately backed inducing confidence that the value of one stablecoin should be equal to one unit of the pricing currency such as US dollar. Solvency ratio is calculated which indicates capital available relative to the requirement and effects the pricing scale factor used for increasing or decreasing loan insurance pricing. The pricing model based on equity default swaps (or binary options or otherwise) is used to determine the price of loan insurance given the pricing scale factor, volatility of the collateral, jump parameters, hazard rates, etc. and loan specific parameters such as moneyness (amount of overcollateralization, value of collateral above the strike or amount of debt to be taken).

The pricing model is used to define relative pricing between loans which is a pricing curve along the moneyness dimension. The pricing scale acts as a non-linear shift of the pricing curve which simplifies user experience while not compromising much on price discovery. As users interact with the system to add insurance or take loans, and asset prices drift, this activity is recognized as a credit or debit against the risk budget. Thus market price discovery is based on risk budget imbalances rather than canonical order book volume imbalances. Changes to the risk budget effect the scaling of prices with the intention to drive risk to a target solvency. The performance functions calculate risk adjusted performance (RAROC), an indicator of system health which measures the percentage returns that the insurance pool is earning per unit of solvency capital requirement and accounts for expected loses. Insurer performance is also calculated, it is the percent amount earned relative to the value of their tokens in the insurance pool. Fee payment functions facilitate the collection of VIG payments from borrowers and allocate it to the individual insurers based on their percent contribution to solvency (the amount by which solvency is improved by including the given insurer).

A percentage of the VIG payment is sent to a reserve which acts as an insurer of last resort to cover the case where the stress tests are incorrect i.e. stress losses. Bailout function is called if the collateral backing any loan becomes insufficient. Bailout reallocates both the debt and the impaired collateral tokens from the borrower to the insurers in a pro-rata fashion according to percent contribution to solvency thus recapitalizing the bad debt. This is referred to as frictionless bailout because the insurance pool is available to service bailouts ahead of a market stress event and no auctions are required.

Users cast votes when transacting to delegate power to custodians who control the contract via multisignature permissioning for software updates and changes to configurations (solvency target, acceptable collateral token types, debt ceiling limits). In order to be eligible to vote for a time period, the users must win a random lottery and meet minimum usage requirements such as an amount of VIG fees paid or earned over a history. The system is thus a crypto borrow and earn community run by its users with clearly separated roles and responsibilities of the three participants, borrower, insurer, and custodian. If borrowers do not have VIG available for fee collection then they are designated as late and eventually the system executes a delinquency bailout (a bailout where the user retains excess collateral minus a delinquency fee). Borrowers that avoid late payments or bailouts are rewarded with improved credit score whereas borrowers with a history of being late or a history of bailouts suffer a reduction in credit score. Borrowers with good credit scores receive discounts on pricing. Currently there is an MVP of VIGOR stablecoin deployed on the eosin jungle testnet.

Margin and Leverage Protocol

The system can be run with the stablecoin being captured internally and is thus a peer-to-pool margin protocol. In this alternative configuration users cannot withdraw stablecoin. The functionality is then described as a peer-to-pool leverage or margin and shorting protocol. The result is the equivalent of porting the margin business out of an exchange to be run standalone. The users of this will be able to take leveraged positions, take short positions, and go to neutral exposure (long stablecoin). The system according to such embodiments can uniquely offer this functionality because it packages together both the ability to lever long and short with an insurance pool backing the activity. The underlying mechanisms work the same as described for the external stablecoin system using risk and pricing with the major difference that the user will interact with the reserve for liquidity. The contract is not an exchange however, there are no order books, and all positions interact with the reserve at the oracle feed prices not relying on user bid/ask quotes. Also it does not have characteristic of an exchange in that users deposit tokens and withdraw that same token when done (minus P&L on their positions). To take a short position a user will deposit risky tokens into insurance pool, place them into reserve to get internal stablecoin at oracle feed price then lock stablecoin into collateral to borrow risky tokens from the insurance/lending pool to place into reserve to get internal stablecoin, The process can repeat to obtain desired short leverage. The use case for someone wanting to go leverage long would lock risky tokens into collateral, borrow stablecoin from the insurance pool and place it into the reserve to get risky tokens at oracle feed price. The process can repeat to get desired leverage.

As with the external stablecoin system, this system also relies on insurers to deposit tokens which back the internal stablecoin loans and token lending to cover bailouts in market stress events. Since the contract is not releasing stablecoin externally this technology can be deployed and run by anyone, many instances can coexist. The supply of an internal stablecoin is only an internal accounting measure and no stablecoin is issued outside the contract nor would any secondary market develop. It is standalone and can be deployed for example as a widget in any crypto wallet. Each deployment would be it's own standalone pool of insurance tokens enabling margin and shorting. Each deployment will use the same VIG token as the fee token and reserve asset so that they are inter operable and each team would not need their own token. It is then a protocol and a standard to be adopted powered by VIG.

Stablecoin Classification as a Hybrid

In some embodiments, the stablecoin may be described as a hybrid Crypto-collateralized and Non-collateralized Stablecoin for the following reasons. The stablecoin holders are not legal owners of the cryptocurrency underlying, not even the DAC is—as it is only managing assets contained in a smart contract. The cryptocurrency collateral and insurance pool and reserve do not directly back the stablecoin, but act as an indirect hedge, and there exists an algorithm to induce confidence regarding stability involving measuring capital adequacy and solvency and adjusting prices accordingly based on risk budgeting. These two categories are generalized as follows: Cryptocurrency-backed: In this case the underlying value of reference is given by usually a basket of other major cryptocurrencies (like Bitcoin, Ethereum or Ripple) owned either by the token holder or the issuer. Non-Collateralized. In this category of Stablecoin, each unit does not directly represent another asset and its value, and the stability characteristics are given by a different mechanism, for example a complex “seigniorage” algorithm or other processes not involving an immediate backing of a commodity, a currency or a cryptocurrency.

Example Architecture

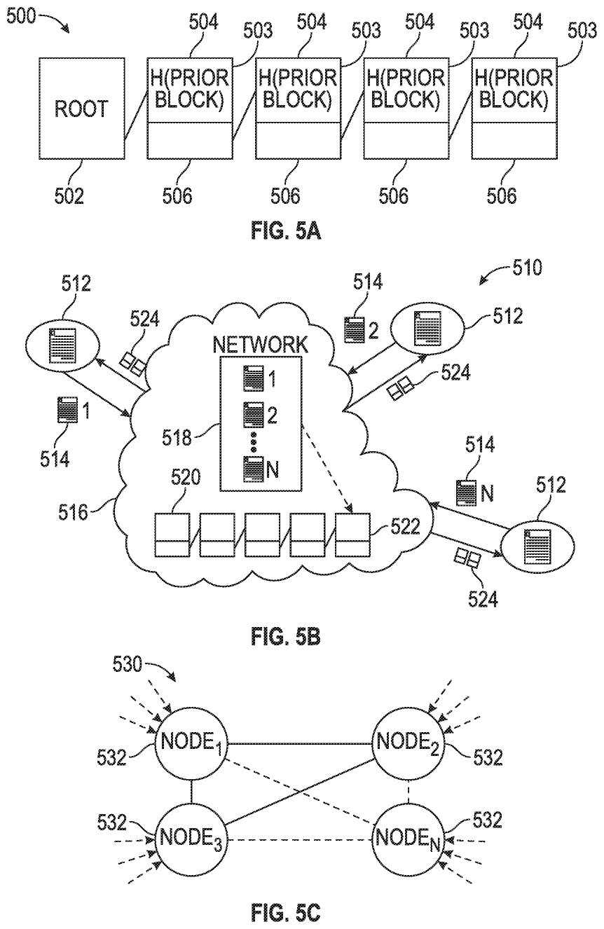

FIG. 5A-C illustrate an example blockchain network in accordance with some examples of the present disclosure. In particular, FIG. 5A illustrates a blockchain data structure 500 made up of a sequence of linked block data structures. A root block 502 typically forms the basis, sometimes referred to as a genesis block, for a blockchain data structure 500. In some aspects, the root block 502 can be a completely self-sufficient seed for an entirely new blockchain data structure 500. For example, the root block 502 of the Bitcoin blockchain does not reference a preceding block and is the original seed from which the Bitcoin blockchain eventually grew. In some other aspects, the root block 502 may be constructed on top of another, already existing blockchain network (e.g., Ethereum, etc.) as a token in order to leverage an existing environment or other features of the underlying network.

The root block 502 can include contextual information, but can also include other information for downstream blocks 503 or participants and/or observers of the blockchain data structure 500 such as metadata, policies, borrower information, lender information, stablecoin data, transaction amount information, risk information, etc. The blocks 503 may be cryptographically linked, directly and indirectly, to the root block 502 via respective headers 504 which can contain a respective hash of the preceding block 503 or root block 502, as appropriate.

A hash refers to the output of an algorithm which may produce a unique, consistent value based on an input with relatively low risk of collision (e.g., two inputs producing the same output). For example and without limitation, using the SHA-256 hashing algorithm on the phrase “genesis node” produces the value: 7856FF57093221558352BDF4D55531D4FCD72BF7CC8BFFBB86E527606A453B9E.

Where the hash is of the preceding block 503 (as compared to where the root block 502 is the preceding block), the respective hash can include the hash contained in the preceding header 504 of the preceding block 503. While cryptography is more widely known for obfuscating data, in the context of a blockchain, a cryptographic hash is used to validate the veracity of the contents of the previous block based on the low risk of collision and the straightforward reproducibility of attempting to reproduce the hash. In other words, any given block can be checked for alteration by simply producing a hash of it and comparing that hash with the hash stored by the block following it. For example, the hash generated above will always be produced from the phrase “genesis node.” However, should the phrase “node genesis” be hashed instead, the hash value will be: E4AFE39853B29E37A44648B9BF376801DCF90302CD894BD04170F919F979479F. Thus, it is merely a matter of reproducing a hash of the contents and comparing against the later recorded hash to verify the authenticity of contents 506 of a block.

The contents 106 of the blocks 503 in a blockchain 500 may contain virtually any type of data. However, as depicted by FIG. 5B, programmable data records, such as one or more smart contracts 514, can be stored as the block content 106. For example, a network 516 may construct a new block 518 containing N, or an arbitrary number of, smart contracts 514. The smart contracts 514 can represent an automated agreement 512 constructed off-network before being provided to the network 516 for recordation and execution. In response, the network 516 can provide a return portion 524 of an updated blockchain 520 including an appended block 522 (which corresponds to the new block 518).

The contents 106 of the blocks 503 in a blockchain 500 may contain virtually any type of data. However, as depicted by FIG. 5B, programmable data records, such as one or more smart contracts 514, can be stored as the block content 106. For example, a network 516 may construct a new block 518 containing N, or an arbitrary number of, smart contracts 514. The smart contracts 514 can represent an automated agreement 512 constructed off-network before being provided to the network 516 for recordation and execution. In response, the network 516 can provide a return portion 524 of an updated blockchain 520 including an appended block 522 (which corresponds to the new block 518).

The network 518 can be a node network 530, as depicted by FIG. 5C. The node network 530 itself may include a multitude of nodes 532 which are responsible for maintaining and authenticating the blockchain 500 by receiving material for updates (such as automated contracts 512) from users. In some aspects, the nodes 532 may require consensus between all N nodes, or a majority of nodes, to validate a new block 518 before an updated blockchain portion 524 may be distributed back to users. In some embodiments, nodes 532 may engage in a race to update the blockchain such as by producing a proof of work such as, for example, solving a puzzle that is difficult to solve but easy to verify (for example, by determining a value which produces a hash of the intended new block having specified characteristics, such as a particular number of leading 0s). In some examples, a proof of stake or other proof may be required for a node 532 to update the blockchain 500. In yet other examples, the nodes 532 may perform the process of executing any programmatic contents of the new block 518, such as when the new block contains a smart contract.

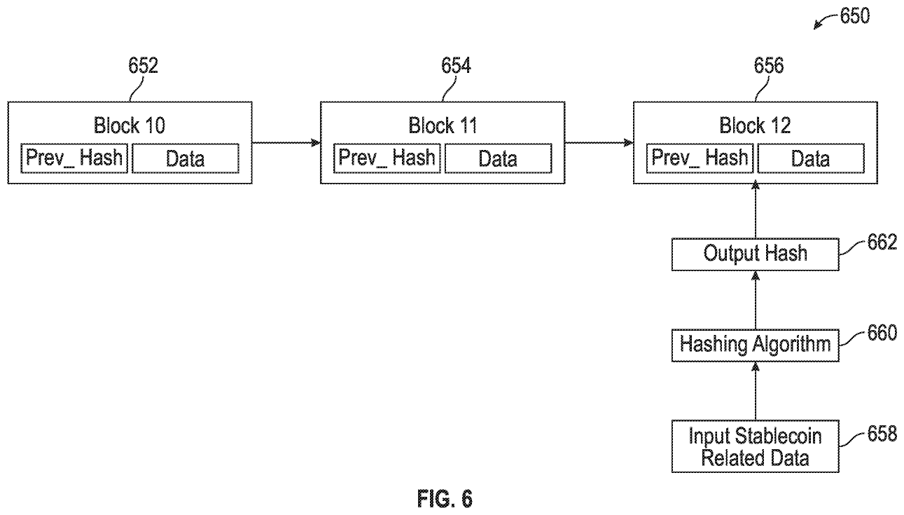

FIG. 6 illustrates another example blockchain configuration 650 according to various aspects of the present disclosure. An example blockchain (e.g., digital ledger) can include blocks 652, 654, 656 used to store data, such as smart contract data and transactions submitted to a blockchain network (e.g. EOSIO, Etherum blockchains). The blocks 652, 654, 656 are records on the blockchain that contain data (e.g., stablecoin data and/or information about stablecoin transactions) and information to verify the blocks 652, 654, 656 are valid parts of the blockchain.

Block 10 (652) shows example block components. As illustrated, block 10 (652) can include data and information about the previous hash. Stablecoin data and/or data about a stablecoin transaction can be stored in the data portion of the block 10 (652). The block 10 (652) can include any data and/or transaction information in a predetermined format. The format can be based on a formatting scheme defined by the blockchain network.

The data portion can also include metadata associated with the stablecoin data and/or transaction, such as, for example, a timestamp, a nonce, a signature, verification data, PoA data, block header information, and/or any other metadata. The nonce can be a random or pseudorandom number issued to ensure that old communications cannot be reused, for example, to carry out replay attacks. In some cases, the nonce can be applied to a message before hashing it in order to prevent a party that reuses the message format/contents having their hashes brute-forced by a third-party with access to the blockchain data.

Block 11 (654) and block 12 (656) show a similar structure with a respective portion of information about the previous hash and a respective data portion which can include stablecoin related data, as discussed herein, including the various assets, information related to the borrower or lender information, and/or data about respective transactions, signatures, verification data, proof of authority data (PoA), block header information, metadata, etc. The different portions of the blocks 652, 654, 656 can be hashed based on a hashing algorithm (e.g., 660).

Each of the blocks 652, 654, 656 can permanently record the transactions and data it contains onto the blockchain. Each block contains information about the previous block, creating a chain of blocks as previously explained.

In one example, input stablecoin data 658 submitted to the blockchain network can be hashed by a hashing algorithm 660, which generates an output hash 662. Hashing algorithm 660 can be any hashing algorithm for securely hashing input data to be stored on the blockchain. In some cases, the output hash 662 can be signed by an endorser (e.g., 624) on the blockchain network. The signed and hashed stablecoin data is then deployed on the blockchain.

In one example, input stablecoin data 658 can include stablecoin data for an entire transaction (cryptocurrency assets provided by lender, borrower, amounts received, determined risk framework). This can include the actual record of the stablecoin transaction as well as any related transaction metadata. In another example, input stablecoin data 658 may not include the data for an entire transaction but rather all transaction metadata (e.g., all communications and records pertaining to a stablecoin transaction but not the final transaction). This record once submitted to the blockchain network 102 and embedded in the blockchain can be used to audit stablecoin transactions, report stablecoin transactions and/or compliance, track stablecoin transactions and/or related data, access stablecoin data, conduct future stablecoin transactions, etc.

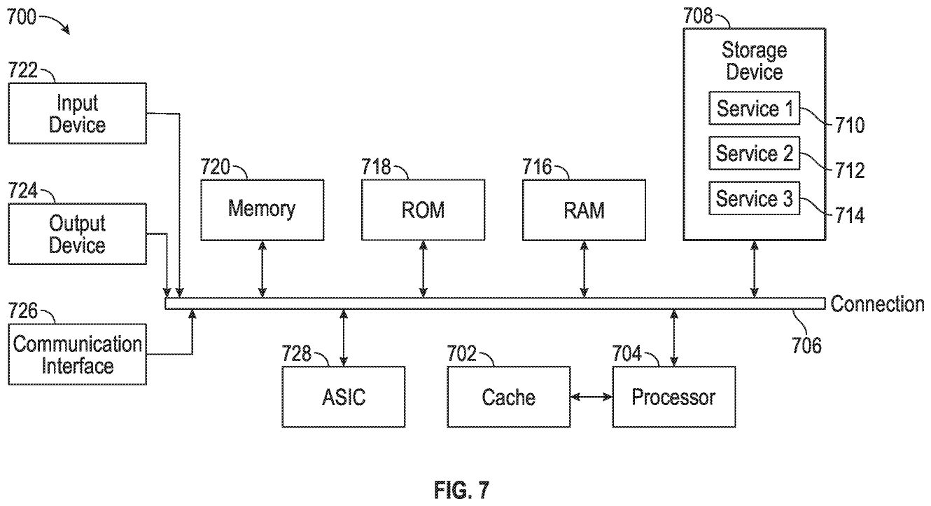

In particular, FIG. 7 illustrates an example architecture of a system 700, including various hardware computing components which are in electrical communication with each other using a connection 706. System 700 includes a processing unit (CPU or processor) 704 and a system connection 706 that couples various system components including the system memory 720, such as read only memory (ROM) 718 and random access memory (RAM) 716, to the processor 704.

The system 700 can include a cache of high-speed memory connected directly with, in close proximity to, or integrated as part of the processor 704. The system 700 can copy data from the memory 720 and/or the storage device 708 to the cache 702 for quick access by the processor 704. In this way, the cache can provide a performance boost that avoids processor 704 delays while waiting for data. These and other modules can control or be configured to control the processor 704 to perform various actions. Other system memory 720 may be available for use as well. The memory 720 can include multiple different types of memory with different performance characteristics.

The processor 704 can include any general purpose processor and a service component, such as service 1 710, service 2 712, and service 3 714 stored in storage device 708, configured to control the processor 704 as well as a special-purpose processor where software instructions are incorporated into the actual processor design. The processor 704 may essentially be a completely self-contained computing system, containing multiple cores or processors, a bus, memory controller, cache, etc. A multi-core processor may be symmetric or asymmetric.

To enable user interaction with the computing device 700, an input device 722 can represent any number of input mechanisms, such as a microphone for speech, a touch-sensitive screen for gesture or graphical input, keyboard, mouse, motion input, speech and so forth. An output device 724 can also be one or more of a number of output mechanisms known to those of skill in the art. In some instances, multimodal systems can enable a user to provide multiple types of input to communicate with the computing device 700. The communications interface 726 can generally govern and manage the user input and system output. There is no restriction on operating on any particular hardware arrangement and therefore the basic features here may easily be substituted for improved hardware or firmware arrangements as they are developed.

Storage device 708 can be a non-volatile memory, a hard disk, or any other type of computer readable media which can store data for access by a computer, such as magnetic cassettes, flash memory cards, solid state memory devices, digital versatile disks, cartridges, random access memories (RAMs) 716, read only memory (ROM) 718, and hybrids thereof. In some cases, storage device 708 can store an execution or runtime environment for executing code, one or more functions for execution via the execution or runtime environment, one or more resources (e.g., libraries, data objects, APIs, etc.), and so forth.

The system 700 can include an integrated circuit 728, such as an application-specific integrated circuit (ASIC) configured to perform various operations. The integrated circuit 728 can be coupled with the connection 706 in order to communicate with other components in the system 700.

The storage device 708 can include software services 710, 712, 714 for controlling the processor 704. In some cases, the software services 710, 712, 714 can include, for example, operating system or kernel services, application services, services associated with one or more functions, etc. Other hardware or software modules are contemplated. The storage device 708 can be connected to the system connection 706. In one aspect, a hardware module that performs a particular function can include the software component stored in a computer-readable medium in connection with the necessary hardware components, such as the processor 704, connection 706, output device 724, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### REFERENCES

[1] Carr, P., and Linetsky, V. A Jump to Default Extended CEV Model: An Application of Bessel Processes. Finance and Stochastics 10, 3 (2006), 303330.
[2] Mendoza-Arriaga, Vadim Linetsky, Pricing Equity Default Swaps under the Jump to Default Extended CEV Model, Finance and Stochastics, September 2011, Volume 15, Issue 3, pp 513540.
[3] Wang D., Rachev S. T., Fabozzi F. J. (2009) Pricing Tranches of a CDO and a CDS Index: Recent Advances and Future Research. In: Bol G., Rachev S. T., Wrth R. (eds) Risk Assessment. Contributions to Economics. Physica-Verlag HD.

1. A stablecoin system comprising:
a smart contract;
a first party inputting an amount of a cryptocollateral asset into the smart contract and receiving a stablecoin loan in return from the smart contract, the cryptocollateral asset having a market value;
the first party purchasing insurance on the cryptocollateral asset market value by paying an insurance fee into the smart contract, the insurance fee comprising an amount of a utility asset and the insurance comprising coverage of a decrease in value of the cryptocollateral below a threshold, a face value of the stablecoin loan;
the insurance fee calculated by a pricing model influenced by a solvency ratio relative to a target, the solvency ratio being equal to a ratio of the amount of cryptocollateral asset to a solvency capital requirement; and
one or more insuring parties inputting an amount of crypto insurance asset and receiving a utility asset from the smart contract, the amount of utility asset received for the crypto insurance asset being a premium earned based on the utility asset input into the smart contract by the first party,
wherein the one or more insuring parties receive ownership of the cryptocollateral asset and the stablecoin debt upon a bail-out event, the bail-out event comprising a drop in the cryptocollateral asset market value below the face value of the stablecoin loan.

2. The system of claim 1, wherein the solvency capital requirement is based on a stress test based on one or more members selected from the group of a Monte Carlo simulation of correlated extreme price events, a value at risk, a conditional value at risk, a expected short fall, any measure of tail risk computed by simulation, a historical data, and a parametric model.

3. The system of claim 1, wherein a stablecoin loan comprises a stablecoin designed to induce confidence to market participants that the value of one stablecoin should equal one unit of a common pricing currency where that pricing currency is a fiat currency.

4. The system of claim 3, wherein the fiat currency is the US dollar.

5. The system of claim 1, wherein the blockchain is an electronic distributed ledger.

6. The system of claim 1, wherein the blockchain is one or more of members selected from the group of EOSIO, ethereum, Cardano, and stellar.

7. The system of claim 1, wherein the smart contract is executed by a processor; and a memory that stores executable instructions that, when executed by the processor, facilitate performance of the smart contract.

8. The system of claim 1 being a token lending system wherein the stablecoin is used as collateral and the crypto insurance asset loaned by the insurer to the borrower is a price risky cryptocollateral asset, and the insurance covers against price increases of the cryptocollateral asset above the value of the stablecoin collateral.

9. A method comprising:
providing, by a peer node associated with a first party, an amount of a cryptocollateral asset into a smart contract residing on a blockchain and receiving a stablecoin loan in return from the smart contract, the cryptocollateral asset having a market value;
sending, by the peer node associated with the first party, a message comprising a request to purchase insurance on the cryptocollateral asset market value covering a loss below a face value of the stablecoin loan by paying an insurance fee, the first party paying the insurance fee by inputting an amount of a utility asset into the main contract,
the insurance fee calculated by a pricing model influenced by a solvency ratio relative to a target, the solvency ratio being equal to a ratio of the amount of cryptocollateral asset to a solvency capital requirement; and
inputting, into the blockchain by one or more peer nodes associated with one or more insuring parties, data identifying an amount of crypto insurance asset and receiving a utility asset from the smart contract, the amount of utility asset received for the crypto insurance asset being a premium earned based on the utility asset input into the central contract by the first party;
detecting, via the smart contract, a bail-out event on the blockchain, the bail-out event comprising a drop in the cryptocollateral asset market value below the face value of the stablecoin loan; and
in response to detecting the bail-out event, propagating, by the smart contract to the blockchain, data providing the one or more insuring parties with an ownership of the cryptocollateral asset and the stablecoin debt.

10. The method of claim 9, wherein the solvency capital requirement is based on a stress test based on a Monte Carlo simulation of correlated extreme price events, or value at risk, or conditional value at risk, or expected short fall, or any measure of tail risk computed by simulation, historical data, or parametric model.

11. The system of claim 9, wherein a stablecoin loan comprises a stablecoin designed to induce confidence to market participants that the value of one stablecoin should equal one unit of a common pricing currency where that pricing currency is a fiat currency.

12. The system of claim 11, wherein the fiat currency is the US dollar.

13. The system of claim 9, wherein the blockchain is an electronic distributed ledger.

14. The system of claim 9, wherein the blockchain is one or more of members selected from the group of EOSIO, ethereum, Cardano, and stellar.

15. The system of claim 9, wherein the blockchain contract is executed by a processor; and a memory that stores executable instructions that, when executed by the processor, facilitate performance of the blockchain contract.

16. The system of claim 9 being a token lending method wherein the stablecoin is used as collateral and the crypto insurance asset loaned by the insurer to the borrower is a price risky cryptocollateral asset, and the insurance covers against price increases of the cryptocollateral asset above the value of the stablecoin collateral.

17. A stablecoin system comprising:
a main contract residing on a blockchain;
a first party inputting an amount of a cryptocollateral asset into the main contract and receiving a stablecoin loan in return from the main contract, the cryptocollateral asset having a market value;
the first party purchasing insurance on the cryptocollateral asset market value covering a loss below a face value of the stablecoin loan by paying an insurance fee, the first party paying the insurance fee by inputting an amount of a utility asset into the main contract;
the insurance fee calculated by a pricing model influenced by a solvency ratio relative to a target, the solvency ratio being equal to a ratio of the amount of cryptocollateral asset to a solvency capital requirement; and
one or more insuring parties inputting an amount of crypto insurance asset and receiving a utility asset from the central contract, the amount of utility asset received for the crypto insurance asset being a premium earned based on the utility asset input into the central contract by the first party,
wherein the one or more insuring parties receive ownership of the cryptocollateral asset and the stablecoin debt upon a bail-out event, the bail-out event comprising a drop in the cryptocollateral asset market value below the face value of the stablecoin loan.

18. The system of claim 17, wherein the solvency capital requirement is based on a stress test based on a Monte Carlo simulation of correlated extreme price events.
